(19) United States
(12) Patent Application Publication
(10) Pub. No.: US 2014/0347276 A1
(43) Pub. Date: Nov. 27, 2014

(54) ELECTRONIC APPARATUS INCLUDING TOUCH PANEL, POSITION DESIGNATION METHOD, AND STORAGE MEDIUM

(71) Applicant: CASIO COMPUTER CO., LTD., Tokyo (JP)

(72) Inventors: Shohei SAKAMOTO, Tokyo (JP); Hiroyuki KATO, Tokyo (JP); Katsunori TSUTSUMI, Tokyo (JP); Kanako NAKANO, Tokyo (JP)

(73) Assignee: CASIO COMPUTER CO., LTD., Tokyo (JP)

(21) Appl. No.: 14/282,188

(22) Filed: May 20, 2014

(30) Foreign Application Priority Data
May 21, 2013 (JP) 2013-107268

(51) Int. Cl. G06F 3/0354; G06F 3/0488; G06F 3/041

(52) U.S. Cl. CPC G06F 3/03547; G06F 3/041; G06F 3/04883; G06F 2203/0338; G06F 2203/04104; G06F 2203/04801; G06F 2203/04808
USPC 345/158; 345/173

(57) ABSTRACT

An electronic apparatus including a display section with a touch panel displays a pointer for position designation on a screen of the display section while an operation mode is switched to a predetermined operation mode, and causes an entire region of the touch panel to function as a virtually transparent touchpad, and executes operation process including controlling a display position of the pointer in the display section in accordance with an input operation to the touch panel. For this reason, it is not necessary to display anything on the screen of the display section in order to indicate the virtual touchpad, and there is no possibility that the screen region that is operable is decreased or a part of a plurality of icons and the like disposed on the screen are hidden.

### CROSS-REFERENCE TO RELATED APPLICATION

This application claims the benefit of Japanese Patent Application No. 2013-107268, filed on May 21, 2013, the entire disclosure of which is incorporated by reference herein.

### FIELD

This application relates to a graphical user interface technique of an electronic apparatus including a touch panel.

### BACKGROUND

Over recent years, the number of compact electronic apparatuses mounted with a touch panel including a transparent electrode on a display screen is increasing. Such electronic apparatuses make it possible to realize a GUI (Graphical User Interface) and, in addition, to ensure a good operational feeling by directly designating an icon or the like being displayed, without being additionally connected with a touchpad or another pointing device such as a mouse and the like.

However, even in an electronic apparatus mounted with a touch panel, when, for example, a display screen has a small area, a size of an icon or the like displayed on the screen is also small, and therefore, it is difficult to perform a delicate pointing operation upon an operation with a finger without using a pen (stylus).

On the other hand, as a technique making this problem soluble, National Patent Publication No. 2011-526396, for example, describes a technique, in which a virtual touchpad is allocated to a part of a touch panel and a pointer position is moved by an operation on this touch panel to make a delicate pointing operation possible.

### SUMMARY

An electronic apparatus according to a first aspect of the present invention is an apparatus comprising a display section including a touch panel, the electronic apparatus comprising:

a detection section for detecting position coordinates of an input operation on the touch panel as a touch position;

a first position designation section for designating a position on the display section in a predetermined process in accordance with an absolute touch position detected by the detection section; and

a second position designation section for designating a position on the display section in the predetermined process in accordance with a change of a relative touch position detected by the detection section, wherein

both the first position designation section and the second position designation section are possible to designate an arbitrary position on the display section in the same predetermined process in accordance with the touch position or the change of the touch position detected by the detection section, corresponding to the input operation performed at an any position within a same predetermined region on the touch panel.

A position designation method according to a second aspect of the present invention is a method in an electronic apparatus comprising a display section including a touch panel, the method comprising:

a detection step of detecting position coordinates of an input operation on the touch panel as a touch position;

a first position designation step of designating a position on the display section in a predetermined process in accordance with an absolute touch position detected by the detection step; and

a second position designation step of designating a position on the display section in the predetermined process in accordance with a change of a relative touch position detected by the detection step, wherein

both the first position designation step and the second position designation step are possible to designate an arbitrary position on the display section in the same predetermined process in accordance with the touch position or the change of the touch position detected by the detection step, corresponding to the input operation performed at an any position within a same predetermined region on the touch panel.

A computer-readable non-transitory storage medium according to a third aspect of the present invention is a computer-readable non-transitory storage medium storing a program for causing a computer included in an electronic apparatus comprising a display section including a touch panel to perform:

a detection function to detect position coordinates of an input operation on the touch panel as a touch position;

a first position designation function to designate a position on the display section in a predetermined process in accordance with an absolute touch position detected by the detection function; and

a second position designation function to designate a position on the display section in the predetermined process in accordance with a change of a relative touch position detected by the detection function, wherein

both the first position designation function and the second position designation function are possible to designate an arbitrary position on the display section in the same predetermined process in accordance with the touch position or the change of the touch position detected by the detection function, corresponding to the input operation performed at an any position within a same predetermined region on the touch panel.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

A more complete understanding of this application can be obtained when the following detailed description is considered in conjunction with the following drawings, in which:

FIG. 1 is a block diagram illustrating an electronic apparatus according to the present invention;

FIG. 2 is a flowchart illustrating an operation of an electronic apparatus;

FIG. 3 is a flowchart illustrating a graphical user interface operation of an electronic apparatus;

FIG. 4 is a flowchart following FIG. 3; and

FIG. 5 is figures illustrating operating states of an electronic apparatus.

### DETAILED DESCRIPTION

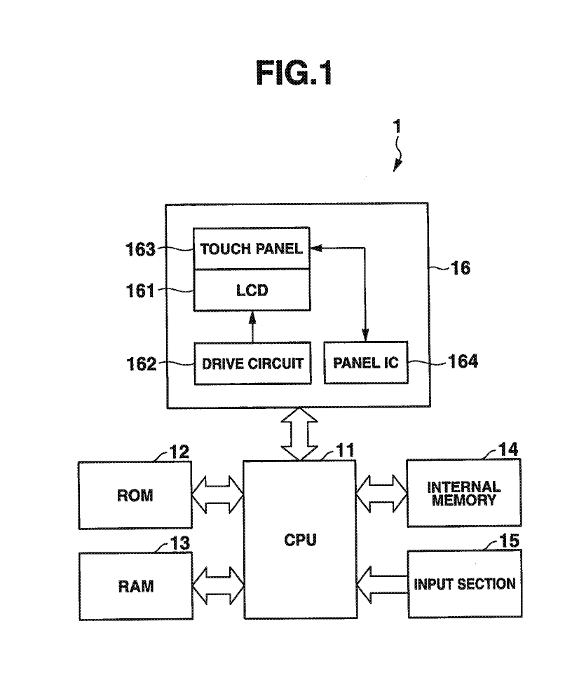

Embodiments of the present invention will now be described. FIG. 1 is a block diagram illustrating main sections of an electronic apparatus 1 applied with the present invention. This electronic apparatus 1 is, for example, a mobile phone, a Smart Phone, a PDA (Personal Digital Assistant), a digital camera, a tablet type information processing terminal, or a wrist watch type information processing terminal attachable to the wrist of a human body, each of which includes a display screen mounted with a touch panel.

The electronic apparatus 1 includes a CPU (Central Processing Unit) 11 for controlling the entire apparatus, a ROM (Read Only Memory) 12, a RAM (Random Access Memory) 13, an internal memory 14, an input section 15, and a display section 16.

The ROM 12 stores various types of programs for causing the CPU 11 to control the electronic apparatus 1. The various types of programs include programs for causing the CPU 11 to execute process to be described later.

The RAM 13 is a working memory and temporarily stores various types of data when the CPU 11 controls the electronic apparatus 1.

The internal memory 14 includes a flash memory and others and stores, for example, image data of still images and moving images, address book including telephone directory data, mail data, schedule data, document data, and music data.

The input section 15 includes various types of operation buttons including a power key, and inputs an operation instruction from the user with respect to the electronic apparatus 1 to the CPU 11 as an electric signal.

The display section 16 includes a TFT type LCD (Liquid Crystal Display) 161 for displaying information such as a character, an image, and the like, a drive circuit 162, a touch panel 163 assembled on a surface of the LCD 161, and a panel IC (Integrated Circuit) 164.

The drive circuit 162 drives the LCD 161 in accordance with an instruction from the CPU 11, and displays a character, an image, and the like on a screen of the LCD 161.

The touch panel 163 is a capacitance type, and has a common configuration, not illustrated, causing a large number of electrode portions arrayed in XY directions formed with a plurality of rows of electrode patterns extending in an X direction and a plurality of columns of electrode patterns extending in a Y direction formed of an ITO (Indium Tin Oxide) layer disposed on the same flat surface of a transparent substrate to function each as a sensor.

The panel IC 164 is a controlling IC for the touch panel 163, and individually drives respective electrode patterns of the plurality of rows and the plurality of columns of the touch panel 163 in a predetermined order to acquire capacitances of a large number of electrode portions arrayed in the XY directions as a detection value expressed in a row unit or a column unit.

Then, the panel IC 164 acquires status information indicating an operating state such as a touch state, a release state where the touch state is changed to a state of being untouched, a multi-touch state (a state where two locations are touched at the same time), and the like with respect to the touch panel 163, and position information indicating a touch position (a position in xy coordinates), based on the acquired detection value, and feeds these items to the CPU 11 as touch information (operation information).

More specific description is made below. When a detection value of an electrode pattern in any row or column is changed, event information indicating this change is fed to the CPU 11 from the panel IC 164, and then touch information is fed to the CPU 11 in accordance with a request from the CPU 11 fed with the event information as a trigger.

The electronic apparatus 1 having the aforementioned configuration has two types of operation modes including a touch panel mode and a touchpad mode as operation modes upon operating the electronic apparatus 1 using the touch panel 163 by the user.

The touch panel mode is an operation mode enabling the electronic apparatus 1 to perform the same operation as in a common electronic apparatus including a touch panel. In contrast, the touchpad mode is an operation mode for displaying a pointer for position designation on the display screen of the LCD 161 to be described later and for controlling the display position of the pointer in conjunction with a touch position of the touch panel 163.

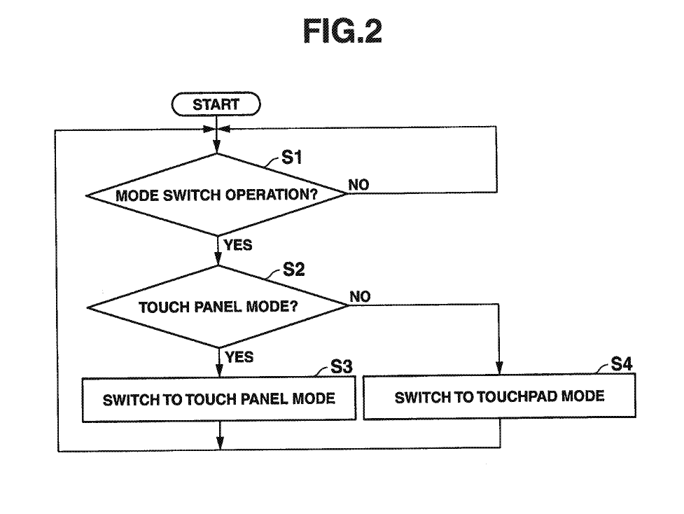

While the electronic apparatus 1 is powered on, the CPU 11 executes the following process illustrated in FIG. 2 in accordance with a program stored on the ROM 12.

In other words, after initiation of an operation with power activation, the CPU 11 sequentially confirms whether the user has performed a switching operation of the operation mode (S1). The switching operation of the operation mode is performed by a predetermined switching operation of the input section 15.

When the switching operation of the operation mode has been performed (S1: YES), the CPU 11 further confirms whether the switching operation by the user is a switch to the touch panel mode (S2).

Then, when the switching operation by the user is a switching operation to the touch panel mode (S2: YES), the CPU 11 switches process in accordance with a touch operation of the touch panel 163 to process based on the touch panel mode, in other words, to common process (S3).

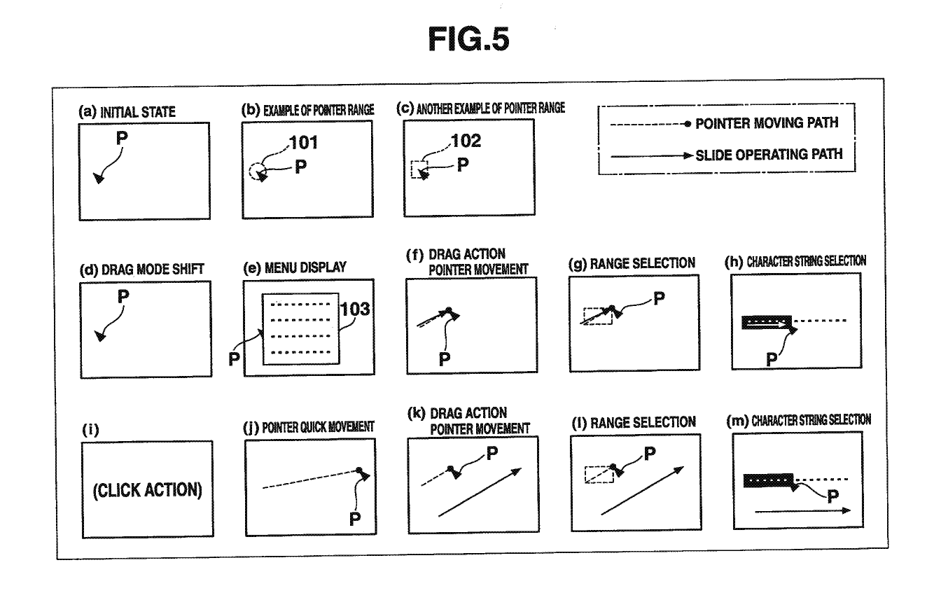

Further, when the switching operation by the user is not a switching operation to the touch panel mode (S2: NO), the CPU 11 switches process in accordance with a touch operation of the touch panel 163 to process based on the touchpad mode (S4). Upon such process, the CPU 11 displays a pointer P for position designation on a display screen of the display section 16, as illustrated in FIG. 5(a).

FIG. 5(a) to (m) are views illustrating operating states of the electronic apparatus 1 in the touchpad mode and also illustrating display examples of the display screen of the display section 16.

Hereinafter, the CPU 11 repeats the aforementioned process during power activation to appropriately switch the operation mode in accordance with a request of the user. Even when the operation mode is any one of the touch panel mode and the touchpad mode, the CPU 11 acquires touch information (status information and position information indicating a touch position) from the panel IC 164 as needed during power activation.

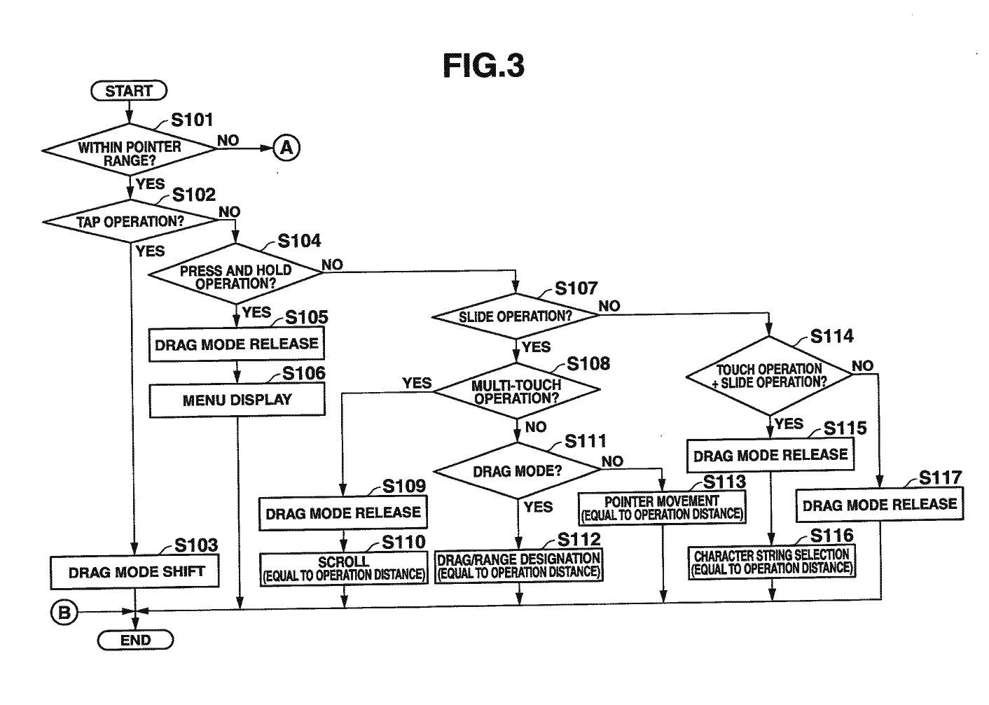

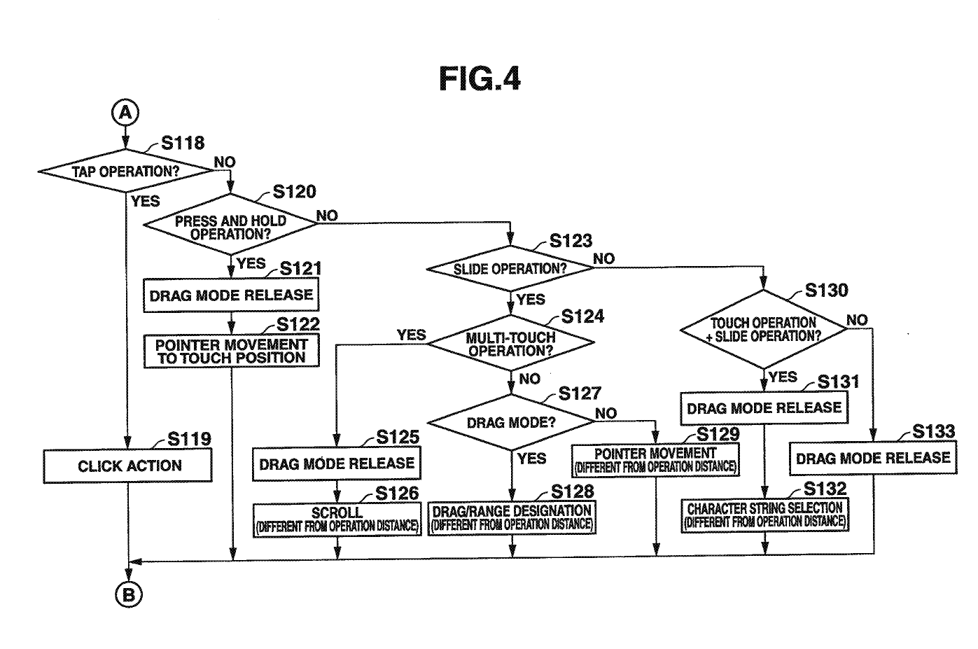

On the other hand, FIG. 3 and FIG. 4 are flowcharts schematically illustrating basic graphical user interface process (operation process) executed by the CPU 11 in accordance with a touch operation of the touch panel 163 by the user while the operation mode remains switched to the touchpad mode.

As illustrated in FIG. 3, when a touch operation is performed to the touch panel 163, the CPU 11 in the touchpad mode initially confirms whether a touch position falls within a pointer range (S101). The pointer range is, for example, a range 101 or 102 indicated by a dashed line in FIG. 5(b) or FIG. 5(c), respectively, and refers to a predetermined range where the pointer P being displayed can be determined to has been touched.

Thereafter, when the touch position falls within the pointer range (S101: YES), the CPU 11 confirms which one of a tap operation, a press and hold operation, a slide operation, a multi-touch operation, and a touch operation+a slide operation a content of the touch operation (input operation) indicates, from the touch information acquired from the panel IC 164, and then executes the following process in accordance with the content of the touch operation.

Initially, when the content of the touch operation indicates a tap operation (S102: YES), the CPU 11 immediately moves to a drag mode and also changes a shape of the pointer P as illustrated in FIG. 5(d) to inform the user of a shift to the drag mode (S103).

Further, when a shift to the drag mode has been already made, the drag mode is released.

The drag mode refers to an operating state where the pointer P is selected and an operating state in which when in the display screen, an arbitrary object such as an icon is present in a point where the pointer P is located, the object is caused to be in a selection state.

Further, when the touch operation is a press and hold operation (S102: NO, S104: YES), the CPU 11 releases the drag mode (S105) and displays a menu 103 (a so-called context menu that is a list of available operations) in a display position of the pointer P as illustrated in FIG. 5(e) (S106). When the shift is not made to the drag mode upon the press and hold operation, the process of S105 is skipped.

Further, when the touch operation is a slide operation (S107: YES) and the operation is performed in a multi-touch state where a plurality of points are touched at the same time (S108: YES), the CPU 11 releases the drag mode (S109) and then executes process for scrolling the display screen (S110). A scroll direction at that time is any one of vertical and horizontal directions depending on the slide operation. Further, upon the aforementioned process, the CPU 11 causes a scroll amount to equal to a moving distance of the finger at the time of the slide operation. When the shift is not made to the drag mode upon the slide operation, the process of S109 is skipped.

In contrast, when the slide operation is not in the multi-touch state (S 108: NO) and a shift is made to the drag mode (S111: YES), the CPU 11 executes drag process (S112).

Upon the drag process, when an object is present in a point where the pointer P is located, as illustrated in FIG. 5(f), the CPU 11 moves the pointer P and an arbitrary object (omitted in the figure) being in the selection state by the same distance as a slide operating amount (a moving distance of the finger).

Further, upon the drag process, when no object is present in a point where the pointer P is located, as illustrated in FIG. 5(g), the CPU 11 moves the pointer P by the same distance as a slide operating amount and also causes a rectangular region where a moving path of the pointer P is a diagonal line to be in a range designation state.

Thereby, the user can designate a desired range in the display screen and also can visualize the range. Further, when objects are present in the range, one or a plurality of corresponding objects can be designated.

Further, when the shift is not made to the drag mode (S111: NO), as illustrated in FIG. 5(f), in other words, when the pointer range is touched with a finger and then the finger is slided as is, the CPU 11 moves only the pointer P by the same distance as the slide operation (S113).

Further, when the slide operation is a touch operation+a slide operation (S114: YES), the CPU 11 executes the following process.

In the present embodiment, the touch operation+the slide operation is an effective touch operation when character information such as a sentence is displayed in a partial or entire region of the display screen and also the pointer P is located in a character display region, and is an operation for sliding a second finger from the aforementioned pointer range as a starting point while the pointer range is touched with a first finger.

Then, when the slide operation is the touch operation+the slide operation, the CPU 11 releases the drag mode (S115) and executes process for causing a character string on a path of the second finger to be in a selection state (S116).

FIG. 5(h) is a view illustrating a slide operating path of the second finger, a moving path of the pointer P, and a selection state of a character string in the process of S116, and also in the process, the CPU 11 causes a moving amount of the pointer P to equal to a slide operating amount (a slide operating amount of the second finger).

Thereby, the user can select a desired character string portion in such a manner that after the pointer P is moved to the top of a character string to be selected, for example, a pointer range is touched with the index finger and then its neighborhood is touched with the middle finger, followed by sliding the middle finger on the character string so as to be removed from the index finger. When the shift is not made to the drag mode upon the touch operation+the slide operation, the process of S116 is skipped.

Further, when the content of the touch operation indicates, for example, an operation other than the aforementioned operation such as the multi-touch operation (S114: NO), the CPU 11 solely releases the drag mode (S117). When the shift is not made to the drag mode, the process of S117 is skipped.

On the other hand, separately from the aforementioned process, even when a touch position upon a touch operation to the touch panel 163 falls outside aforementioned pointer range (S101: NO), the CPU 11 confirms which one of the tap operation, the press and hold operation, the slide operation, the multi-touch operation, and the touch operation+the slide operation the content of the touch operation indicates and then executes the following process in accordance with the content of the touch operation.

In other words, as illustrated in FIG. 4, when the content of the touch operation indicates the tap operation (S118: YES), the CPU 11 executes click process (S119). FIG. 5(i) is a view conveniently illustrating an operation of the electronic apparatus 1 in the process.

The click process is the same process as upon a click (left click) operation during use of a mouse in a personal computer or the like and the same process as upon the tap operation when the touch panel mode is set. More specifically, when, for example, a button for instructing the initiation of a predetermined operation is displayed in a touch position, the click process is process for initiating the predetermined operation.

Further, when the touch operation is the press and hold operation (S120: YES), the CPU 11 releases the drag mode (S121) and moves the pointer P located in an arbitrary position to the touch position as illustrated in FIG. 5(j) (S122). Thereby, the user can quickly move the pointer P distantly positioned to a desired position within the display screen.

Although not illustrated, when the shift is not made to the drag mode upon the press and hold operation, the process of S121 is skipped.

Further, when the touch operation is the slide operation (S123: YES) and is performed in the multi-touch state where a plurality of points are touched at the same time (S124: YES), the CPU 11 releases the drag mode (S125) and thereafter executes process for scrolling the display screen (S126).

However, a scroll amount in the process is a scroll amount equivalent to, for example, a distance of a ratio predetermined with respect to a moving distance of a finger during the slide operation, differently from the process of S110 of FIG. 3 described above, and is larger or smaller than the slide operating amount,.

Further, when the slide operation is not performed in the multi-touch state (S124: NO) and a shift is made to the drag mode (S127: YES), the CPU 11 executes drag process (S128).

A specific content of the drag process in such process is the same as in the process of S112 of FIG. 3 described above. However, a moving amount of the pointer P is a moving amount smaller than a slide operating amount and a moving amount equivalent to a distance of a ratio predetermined with respect to the slide operating amount.

FIGS. 5(k) and (l) illustrate a relationship between a slide operating amount and a moving amount of the pointer P during the drag process of S128 and views equivalent to FIG. 5(f) and (g), respectively.

Further, when the slide operation is not performed in the multi-touch state (S124: NO) and the shift is not made to the drag mode (S127: NO), in other words, when after a position outside a pointer range is touched with a finger, the finger is slid as is, the CPU 11 moves only the pointer P as illustrated in FIG. 5(k) (S129).

Also in this case, a moving amount of the pointer P is a moving amount smaller than, for example, a moving amount of the finger during the slide operation, similarly to the case during the drag process of S128.

Further, when the slide operation is the touch operation+the slide operation (S130: YES), the CPU 11 executes the following process.

A specific operation of the touch operation+the slide operation in this case is basically the same as the operation described above. However, a touch position of the first finger is an arbitrary position differing from the aforementioned pointer range and an operation of the second finger is a slide operation in which a neighborhood of the touch position of the first finger is a starting point.

When the slide operation is the touch operation+the slide operation, the CPU 11 releases the drag mode (S131) and thereafter causes a character string of a range equivalent to a distance smaller than a moving distance of the second finger and to a distance of a ratio predetermined with respect to the distance to be in a selection state (S132).

FIG. 5(m) is a view illustrating a slide operation path of the second finger, a moving path of the pointer P, and a selection state of a character string upon process of S132, and a view corresponding to FIG. 5(h).

Thereby, the user can select a desired character string portion in such a manner that the user moves the pointer P to the top of a character string to be selected; then touches an arbitrary position outside a pointer range, for example, with the index finger and its neighborhood with the middle finger; and slides the middle finger in an arrangement direction of the character string so as to be removed from the index finger.

Further, when a content of the touch operation indicates an operation other than the aforementioned operation (S130: NO), the CPU 11 only releases the drag mode (S133). Although not illustrated, when the shift is not made to the drag mode, the process of S133 is skipped.

As described above, the electronic apparatus 1 of the present embodiment can switch an operation mode upon a touch operation (input operation) to the touch panel 163 to the touchpad mode as needed. Then, the touchpad mode causes the entire region of the touch panel 163 to function as a virtual transparent touchpad to control a display position of the pointer P for position designation.

Therefore, in the touchpad mode, it is not necessary to display anything on the screen of the display section 16 in order to indicate a virtual touchpad to the user, resulting in no possibility that an operable screen region is decreased or a part of a plurality of icons disposed on the screen are hidden. Accordingly, the operability of the electronic apparatus 1 can be enhanced more than a conventional one.

Further, in the present embodiment, upon the slide operation performed in the touchpad mode, when an initial touch position of the operation fell outside a pointer range, a moving amount of the pointer P was caused to be smaller than a slide operating amount. Therefore, even when, for example, an area of the display screen of the display section 16 is relatively small, the user can perform a delicate pointing operation by a slide operation using the entire region of the display screen as illustrated in FIGS. 5(k) and (l).

Further, in the present embodiment, upon the touch operation, a different action is made depending on a content of the touch operation between when an initial touch position of the operation falls within a pointer range and when the initial touch position of the operation falls outside the pointer range. Therefore, the user can cause the electronic apparatus 1 to perform the operations illustrated in FIG. 5(d) to (h) or to perform the operations illustrated in FIG. 5(i) to (m) differing from the aforementioned operations, as needed, even upon the same content of touch operation.

Specifically, the user can move the pointer P at the same moving amount as a slide operating amount or at a moving amount differing from the slide operating amount by the slide operation as needed.

Further, the user can select a desired character string portion by the touch operation+the slide operation. At that time, the user can cause a selection range to be a range corresponding to a slide operating amount or to be a range narrower than the range corresponding to the slide operating amount as needed.

Further, the user can cause the press and hold operation to quickly move the pointer P to a desired position or cause a menu to be displayed, as needed.

Further, the user can cause the tap operation to make a shift to the drag mode or to perform a click operation, as needed.

Further, the user can cause the slide operation with a multi-touch to scroll the screen at the same scroll amount as a slide operating amount or at a scroll amount differing from the slide operating amount, as needed.

The present embodiment has described that while the operation mode is switched to the touchpad mode, the press and hold operation causes the pointer P to quickly move a desired position or to display a menu. However, such an action may be made in accordance with a predetermined operation differing from the press and hold operation. The predetermined operation includes, for example, a double tap and a touch operation such as drawing a small circle.

Further, in the present embodiment, when the touch operation in the touchpad mode was the slide operation or the touch operation+the slide operation and also the initial touch position fell outside a pointer range, a moving amount of the pointer P was less or narrower than a slide operating amount (a moving distance of a finger during the slide operation). However, the moving amount of the pointer P may be more or wider than the slide operating amount. In this case, a large pointing operation can be realized with a small slide operating amount. Therefore, when an area of the display screen is relatively large, a large pointer movement or drag action can be realized with a small or narrow slide operation.

Further, upon carrying out the present invention, while the operation mode remains switched to the touchpad mode, it is possible to display, in a discriminable manner, the pointer ranges 101 and 102 as illustrated in FIG. 5(b) and FIG. 5(c), respectively, in addition to the pointer P, on the display screen of the display section 16. The pointer ranges 101 and 102 are indicated by a dashed line, a solid line, or the like or by an arbitrary method such as expression with a color differing from the color of a surrounding region.

In this case, when causing the electronic apparatus 1 to make a desired action by selecting an initial touch position of an operation, the user can easily discriminate a touch position necessary to realize the desired action. Accordingly, it is possible to enhance usability upon operating the electronic apparatus 1 in the touchpad mode.

Further, the present embodiment has described that moving amounts of the pointer and the object in a slide operation within a pointer range are the same as a slide operating amount, but the moving amounts and the slide operating amount may be adjusted to be substantially the same in view of a position gap between a pointer position and a touch position.

While the present invention has been described with reference to the preferred embodiments, it is intended that the invention be not limited by any of the details of the description therein but includes all the embodiments which fall within the scope of the appended claims.

What is claimed is:

1. An electronic apparatus comprising a display section including a touch panel, the electronic apparatus comprising:
a detection section for detecting position coordinates of an input operation on the touch panel as a touch position;
a first position designation section for designating a position on the display section in a predetermined process in accordance with an absolute touch position detected by the detection section; and
a second position designation section for designating a position on the display section in the predetermined process in accordance with a change of a relative touch position detected by the detection section, wherein
both the first position designation section and the second position designation section are possible to designate an arbitrary position on the display section in the same predetermined process in accordance with the touch position or the change of the touch position detected by the detection section, corresponding to the input operation performed at an any position within a same predetermined region on the touch panel.

2. The electronic apparatus according to claim 1, wherein
the predetermined process is a process for moving a pointer displayed on the display section,
the first position designation section designates the absolute position on the display section for moving the pointer in accordance with the absolute position coordinates detected by the detection section, and
the second position designation section designates the relative position on the display section for moving the pointer in accordance with the change of the relative position coordinates detected by the detection section.

3. The electronic apparatus according to claim 1, wherein when the input operation is a slide operation, the second position designation section changes a display position of a pointer on the display section in conjunction with the slide operation, and controls a change amount of the display position so that the change amount of the display position differs from a change amount of the touch position in the slide operation.

4. The electronic apparatus according to claim 3, wherein when the input operation is a predetermined input operation except a tap operation and the slide operation, the second position designation section controls the display position of the pointer so that the display position becomes the touch position of the predetermined input operation.

5. The electronic apparatus according to claim 1, wherein
the first position designation section designates the position on the display section in the predetermined process when an initial touch position in the input operation is included by a predetermined region including a display position of the pointer on the display section, and
the second position designation section designates the position on the display section in the predetermined process when the initial touch position is not included by the predetermined region.

6. The electronic apparatus according to claim 5, wherein when the input operation is a slide operation and the initial touch position in the slide operation is included by the predetermined region, the first position designation section controls a change amount of a position of the pointer on the display section so that the change amount of the position of the pointer becomes a change amount substantially equal to a change amount of the touch position in the slide operation.

7. The electronic apparatus according to claim 5, wherein when the input operation is a tap operation and the touch position in the tap operation is included by the predetermined region, the first position designation section executes an operation process that is a shifted predetermined operation mode.

8. The electronic apparatus according to claim 5, wherein when the input operation is a predetermined input operation except a tap operation and a slide operation and also the initial touch position in the input operation is not included by the predetermined region, the first position designation section executes an operation process including performing a predetermined operation in accordance with a predetermined input operation.

9. The electronic apparatus according to claim 5, further comprising a display control section for causing the display section to display the predetermined region in a discriminable manner

10. The electronic apparatus according to claim 1, wherein when the input operation is a simultaneous operation of a touch operation and a slide operation, both the first position designation section and the second position designation section execute an operation process including performing a predetermined operation in accordance with the simultaneous operation.

11. The electronic apparatus according to claim 1, wherein when the input operation is a slide operation by a multi-touch operation, both the first position designation section and the second position designation section execute an operation process including performing a predetermined operation in accordance with the slide operation.

12. The electronic apparatus according to claim 1, further comprising a switch section for making a switch to any one of a touch panel mode and a touchpad mode to be set, wherein
during the touch panel mode, the predetermined process is a process for directly designating the position on the display section, and only the first position designation section functions, and
during the touchpad mode, the predetermined process is a process for moving a pointer displayed on the display section, and both the first position designation section and the second position designation section function at the same time.

13. The electronic apparatus according to claim 1, wherein both the first position designation section and the second position designation section are possible to designate any position of an entire region on the display section in the same predetermined process in accordance with the touch position or the change of the touch position detected by the detection section, corresponding to the input operation performed in an entire region on the touch panel.

14. A position designation method in an electronic apparatus comprising a display section including a touch panel, the method comprising:
a detection step of detecting position coordinates of an input operation on the touch panel as a touch position;
a first position designation step of designating a position on the display section in a predetermined process in accordance with an absolute touch position detected by the detection step; and
a second position designation step of designating a position on the display section in the predetermined process in accordance with a change of a relative touch position detected by the detection step, wherein
both the first position designation step and the second position designation step are possible to designate an arbitrary position on the display section in the same predetermined process in accordance with the touch position or the change of the touch position detected by the detection step, corresponding to the input operation performed at an any position within a same predetermined region on the touch panel.

15. A computer-readable non-transitory storage medium storing a program for causing a computer included in an electronic apparatus comprising a display section including a touch panel to perform:
a detection function to detect position coordinates of an input operation on the touch panel as a touch position;
a first position designation function to designate a position on the display section in a predetermined process in accordance with an absolute touch position detected by the detection function; and
a second position designation function to designate a position on the display section in the predetermined process in accordance with a change of a relative touch position detected by the detection function, wherein
both the first position designation function and the second position designation function are possible to designate an arbitrary position on the display section in the same predetermined process in accordance with the touch position or the change of the touch position detected by the detection function, corresponding to the input operation performed at an any position within a same predetermined region on the touch panel.
